(19) United States
(12) Patent Application Publication
(10) Pub. No.: US 2009/0125806 A1
(43) Pub. Date: May 14, 2009

(54) Instant message system with personalized object and method thereof

(75) Inventors: Chaucer Chiu, Taipei (TW); Sharen Han, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei City (TW)

(21) Appl. No.: 11/979,987

(22) Filed: Nov. 13, 2007

(51) Int. Cl. G06F 17/24; G06F 9/44

(52) U.S. Cl. 715/256; 717/173

(57) ABSTRACT

An instant message system with personalized object and a method thereof are provided, so as to solve the problem that text information of conventional instant message system is difficult to be understood due to expression symbols and text information exit simultaneously. In the instant message system with personalized object, by separating the text information and the personalized object and determining whether the text information has an emotional term, personalized object expression images are selected, and the personalized object expression images are expressed in the personalized object, so as to achieve the efficacy of separating the text information input and the personalized object expression images without influencing the understanding of the text information.

### BACKGROUND OF THE INVENTION

1. Field of Invention

The present invention relates to an instant message system and a method thereof. More particularly, the present invention relates to an instant message system with personalized object for presenting expression symbols and text information respectively and a method thereof.

2. Related Art

With the rapid development of electronic communication, person-to-person chatting processes for making friends have been changed in current society, from the earliest exchange of letters to telephone communication. Nowadays, due to the convenience brought by the application of network, instant message has gradually become a popular person-to-person chatting method for making friends. Therefore, all devices capable of being connected to the network have developed to have instant message software, for the user to have conversation.

In current instant message software, ICQ developed by Mirabilis Company is the earliest, Windows Live Messenger (MSN) developed by Microsoft Corporation and the Skype researched and developed by KaZaA developers are most representative. MSN transmits the text information input by the user to a receiver for receiving, in which a transmitter performs real-time transmission through network.

In order to make the conversation more vivid, expression symbols required by the instant message software come into being, from the initial simple image symbols to the current animation graphic symbols, which deliver the emotional expressions required by the user. However, such animation graphic symbols merely are pure emotional symbol markings, and when the user wants to randomly insert expression symbols during the conversation, the operation is very inconvenient and time-consuming as it is necessary to click the insert position and searching appropriate expression symbols.

A simple method of inserting animation graphic symbols for MSN and Skype has been developed, in which specific input terms are set for the expression symbols in the list one by one. Accordingly, when inputting, the user merely needs to input the specific input terms to insert the expression symbols, thereby simplifying the method for using the expression symbols, such that the input becomes convenient and time-saving.

However, as the expression symbols will be displayed instead of the specific input terms, another problem of affecting the understanding of the input text information occurs, and it is quite inconvenient to understand the text information.

In view of the defects generated during the displaying of the conventional instant message software when replacing the specific input terms, it is necessary to provide an improved expression symbol inputting and displaying method, and how to solve the problem of affecting the understanding of the text information when replacing the specific input terms with the expression symbols during inputting the text information is also an important issue for those in the related field.

### SUMMARY OF THE INVENTION

In view of the status in prior art that the conventional instant message software cannot solve the problem that the text information is difficult to be understood when the text information contains expression symbols simultaneously, the present invention is directed to provide a instant message system with personalized object and a method thereof, so as to solve the problem that the text information simultaneously containing expression symbols is difficult to be understood.

The instant message method with personalized object of the present invention is applicable to instant message between a transmitter and a receiver, and includes the following steps: first, receiving a text information input to the transmitter; next, determining whether the text information has an emotional term or not according to at least one emotional term classification information; then, when the text information has the emotional term, selecting a personalized object state according to the emotional term classification information; thereafter, selecting one among the personalized object expression images according to the personalized object state; and finally, displaying the text information and the personalized object expression image on the personalized objects of the transmitter and the receiver respectively.

The instant message system with personalized object of the present invention is applicable to instant message between a transmitter and a receiver, and the transmitter includes an input module, an emotional term analysis module, and a display module. The input module is used for receiving the text information input to the transmitter. The emotional term analysis module is used for determining whether the text information has an emotional term or not according to at least one emotional term classification information, and selecting one among personalized object expression images according to the personalized object state selected according to the emotional term classification information when the text information has the emotional term. The display module is used for displaying a personalized object of the transmitter and a personalized object of the receiver on the transmitter, and when the text information has the emotional term, displaying the text information and the personalized object expression image on the personalized objects of the transmitter and the receiver respectively.

According to the instant message system with personalized object and the method thereof in the present invention, by activating the function of the instant message and displaying the personalized object, the text information and the personalized object are separated, the personalized object is expressed by vivid personalized object expression images, instead of previous expression symbols, thereby solving the problem that the text information is difficult to be understood when the text information contains expression symbols simultaneously. By determining whether the text information has an emotional term or not, the personalized object expression images are selected without activating the expression symbols by inputting specific key words, so the input is convenient and simple, thereby achieving the efficacy of separating the text information input and personalized object expression images without influencing the understanding of the text information.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of an instant message system with personalized object of the present invention.

FIG. 2 is flow chart of an instant message method with personalized object of the present invention.

FIG. 3A is a correspondence diagram of emotional term classifications and emotional terms of the present invention.

FIG. 3B is a correspondence diagram of emotional term classifications and personalized object states of the present invention.

FIG. 3C is a correspondence diagram of personalized object states and personalized object expression images of the present invention.

FIGS. 4A and 4B are schematic views of operation states of a transmitter and a receiver of the present invention.

FIG. 5 is a block diagram of an update management system of the present invention.

FIG. 6 is a flow chart of update management steps of the present invention.

FIG. 7 is a flow chart of steps of writing files of the present invention.

### DETAILED DESCRIPTION OF THE INVENTION

The present invention is applicable to instant message between a transmitter and a receiver. For convenient illustration, embodiments are illustrated in the direction of from the transmitter to the receiver, but in fact, the transmitter and the receiver can be exchanged, that is to say, the transmitter can also be a receiver, and the receiver can also be a transmitter.

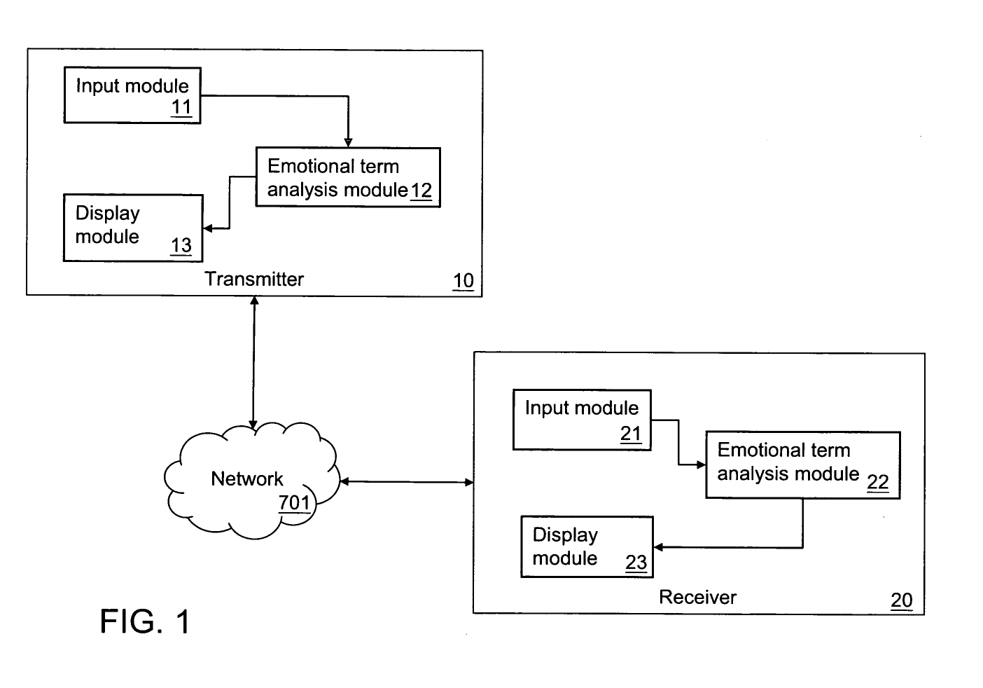

Referring to FIG. 1, a block diagram of an instant message system with personalized object of the present invention is shown. The instant message system with personalized object of the present invention is applicable to instant message between a transmitter 10 and a receiver 20. The transmitter 10 includes an input module 11, an emotional term analysis module 12 and a display module 13. The input module 11 is used for receiving the text information input to the transmitter 10. The emotional term analysis module 12 is used for receiving the text information transmitted by the input module 11, and determining whether the text information has an emotional term or not according to at least one emotional term classification information. If the text information has the emotional term, a personalized object state is selected according to the emotional term classification information, and one among personalized object expression images is selected according to the personalized object state. If the text information does not have the emotional term, the emotional term analysis module 12 will not perform analysis on the text information. The display module 13 is used for displaying a personalized object of the transmitter 10 on the transmitter 10 and a personalized object of the receiver 20 on the transmitter 10, and displaying the text information and the personalized object expression image on the personalized objects of the transmitter 10 and the receiver 20 respectively. The transmitter 10 and the receiver 20 perform two-end instant message through a network 701 to transmit and receive the text information and personalized expression images.

The receiver 20 includes an input module 21, an emotional term analysis module 22 and a display module 13. The input module 21 is used for receiving the text information input to the receiver 20. The emotional term analysis module 22 is used for receiving the text information transmitted by the input module 21, and determining whether the text information has an emotional term or not according to at least one emotional term classification information. If the text information has the emotional term, a personalized object state is selected according to the emotional term classification information, and one among personalized object expression images is selected according to the of personalized object state. The display module 23 is used for displaying a personalized object of the transmitter 20 on the transmitter 20 and a personalized object of the transmitter 10 on the receiver 20, and displaying the text information and the personalized object expression image on the personalized objects of the transmitter 10 and the receiver 20 respectively. The transmitter 10 and the receiver 20 include the same modules, and the same modules execute the same events. Therefore, it can be known clearly that, the transmitter 10 and the receiver 20 can be exchanged, that is to say, the transmitter 10 can also be a receiver 20, and the receiver 20 can also be a transmitter 10.

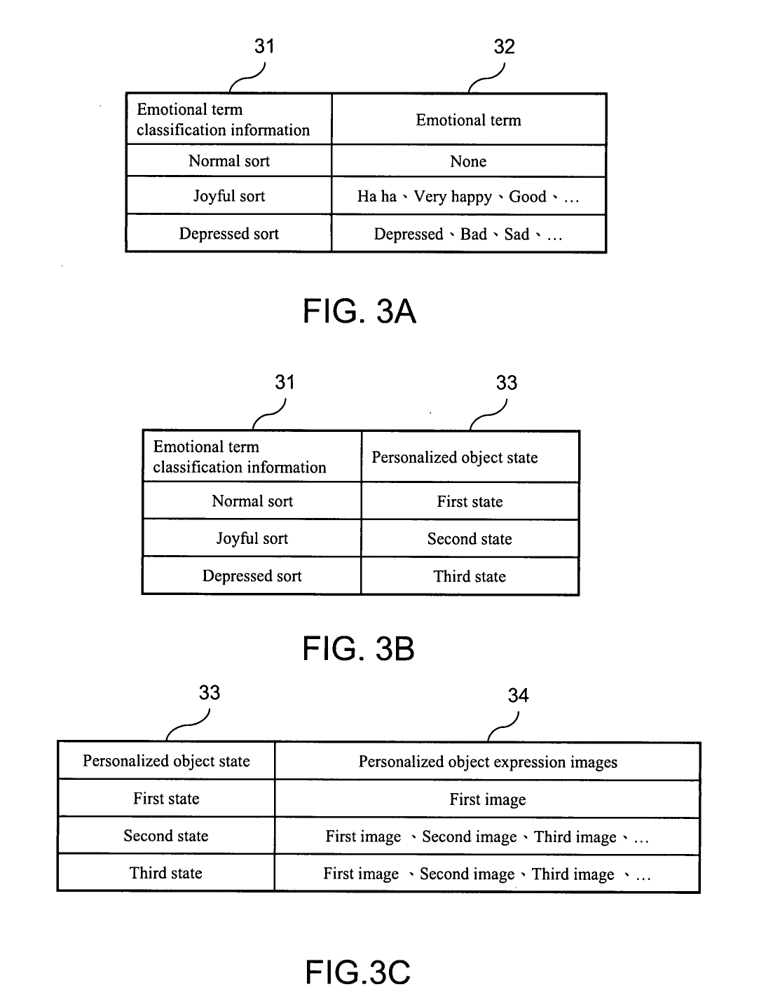

The emotional term classification information classifies colloquial emotional adjectives into different sorts, for example, joyful sort, depressed sort, and normal sort. The personalized object state is corresponding to the emotional term classification information one-to-one and determines the personalized object expression image. The personalized object expression images are the images displayed on the personalized object, and each personalized object state can be corresponding to a plurality of personalized object expression images. Referring to FIGS. 3A to 3C, the emotional term classification information, the personalized object state, and the personalized object expression images can be further understood.

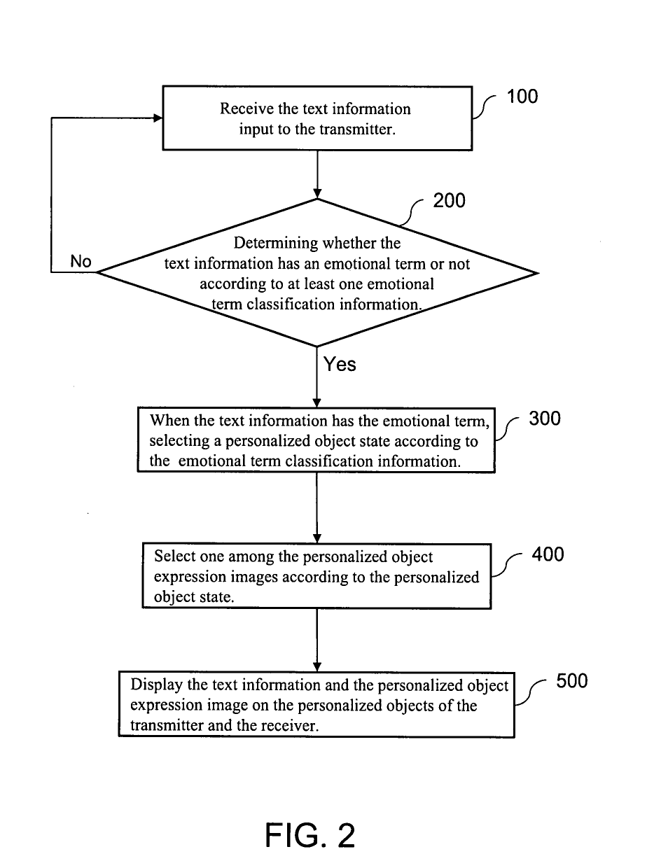

FIG. 2 is a flow chart of an instant message method with personalized object of the present invention. The instant message method with personalized object of the present invention is applicable to instant message between a transmitter 10 and a receiver 20, and includes the following steps: first, receiving the text information input to the transmitter 10 (Step 100); next, determining whether the text information has an emotional term or not according to at least one emotional term classification information (Step 200); then, when the text information has the emotional term, selecting a personalized object state according to the emotional term classification information (Step 300); thereafter, selecting one among the personalized object expression images according to the personalized object state (Step 400); and finally, displaying the text information and the personalized object expression image on the personalized objects of the transmitter 10 and the receiver 20 (Step 500); when the text information does not have the emotional term, returning to the step of receiving the text information input to the transmitter 10 (Step 100).

Referring to FIGS. 3A, 3B, and 3C, FIG. 3A is a correspondence diagram of emotional term classifications and emotional terms of the present invention, FIG. 3B is a correspondence diagram of emotional term classifications and personalized object states of the present invention, and FIG. 3C is a correspondence diagram of personalized object states and personalized object expression images of the present invention.

The selections of the emotional term classification information, the personalized object state, and the personalized object expression image are performed by converting the text information having an emotional term input to the transmitter 10 to the emotional term classification information, the personalized object state, and the personalized object expression images. The conversion is achieved by building three correspondence relationships between the emotional term classification information and the emotional term, the emotional term classification information and the personalized object state, and the personalized object state and the personalized object expression image through a database, and the manner and content of the actual database correspondence are not limited to the disclosure of the present invention.

First, the corresponding process between emotional term classification information 31 and emotional term 32 is illustrated. When the emotional term analysis module 12 receives the text information input to the transmitter 10, the emotional term analysis module 12 will determine whether the text information has the emotional term 32 or not according to at least one emotional term classification information 31, as the correspondence table of emotional term classification information and emotional terms shown in FIG. 3A. When the content of the text information has the emotional term 32, such as “Ha ha”, “Very happy”, “Good”, and etc., the text information belongs to the joyful sort of the emotional term classification information 31. When the content of the text information has the emotional term 32, such as “Depressed”, “Bad”, “Sad”, and etc., the text information belongs to the depressed sort of the emotional term classification information 31. When the content of the text information does not have any emotional terms 32, the text information belongs to the normal sort of the emotional term classification information 31.

Next, the corresponding process between the emotional term classification information 31 and the personalized object state 33 is illustrated. The correspondence table of the emotional term classification information and the personalized object state shown in FIG. 3B is adopted. The emotional term analysis module 12 then selects the personalized object state 33 through the selected emotional term classification information 31. When the selected emotional term classification information 31 belongs to the “joyful sort”, the corresponding personalized object state 33 is a “second state”; when the selected emotional term classification information 31 belongs to the “depressed sort”, the corresponding personalized object state 33 is a “third state”; and when the selected emotional term classification information 31 belongs to the “normal sort”, the corresponding personalized object state 33 is a “first state”.

Finally, the corresponding process between the personalized object state 33 and the personalized object expression image 34 is performed. The correspondence table of the personalized object state and the personalized object expression image shown in FIG. 3C is adopted. The emotional term analysis module 12 selects one among the personalized object expression image 34 according to the selected personalized object state 33. When the personalized object state 33 is the “second state”, one of a “first image”, a “second image”, and a “third image” of the personalized object expression image 34 is selected. For the selection of the “third state” and the “first state” of the personalized object state 33 is as described above, and will not be repeated again herein.

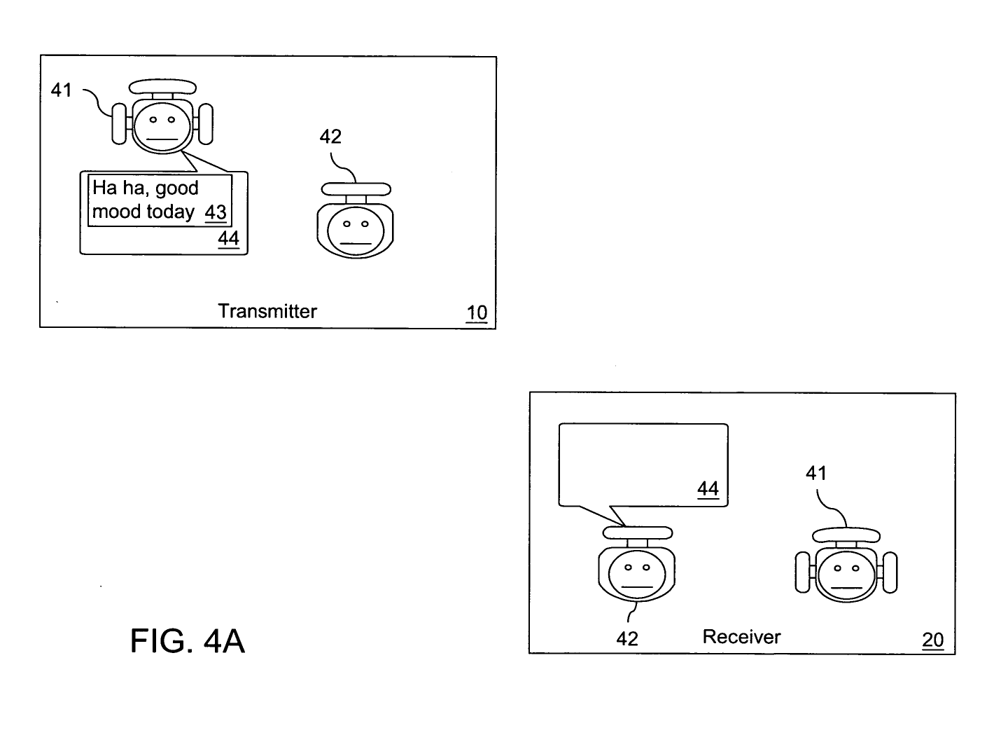

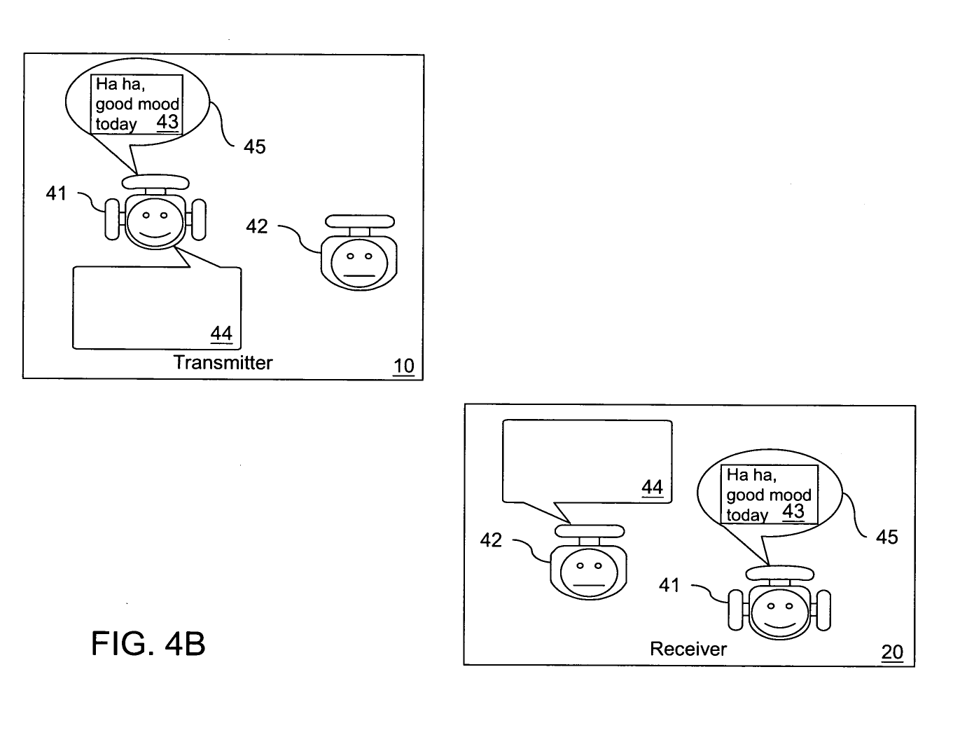

Thereafter, the operation mode and process of the present invention is illustrated with reference to an embodiment and FIGS. 4A and 4B, in which FIGS. 4A and 4B are schematic views of operation states of a transmitter and a receiver of the present invention. As shown in FIG. 4A, a transmitter personalized object 41 and a receiver personalized object 42 are displayed in the transmitter 10, and meanwhile, the transmitter personalized object 41 and the receiver personalized object 42 are displayed in the receiver 20, thus an initial state of the transmitter 10 and the receiver 20 when instant message is established by them. Accordingly, the personalized object state 33 of the transmitter personalized object 41 and the receiver personalized object 42 do not have any emotional terms at the initial state, and the personalized object states 33 of the transmitter personalized object 41 and the receiver personalized object 42 belong to the “first state”. The personalized object expression image 34 selected according to the “first state” is a “first pattern”. Input region 44 is provided around the personalized object 41 for inputting the text information 43. After inputting, click “Confirm” (“Enter” key in the keyboard) to complete the inputting of the text information 43.

After the text information 43 of “Ha ha, good mood today” is input to the transmitter 10, the emotional term analysis module 12 determines the text information 43 has the emotional term 32 “Ha ha” through the correspondence table of the emotional term classification information and the emotional term, the emotional term analysis module 12 will select the emotional term classification information 31 of the “joyful sort” and will select the personalized object state 33 of the “second state”, and then, the personalized object expression images 34 is selected as the personalized object state 33 is the “second state”. In this embodiment, the personalized object expression image 34 is selected to be the “first image”.

After the emotional term analysis module 12 has determined and selected the personalized object expression image 34, the display module 13 displays the text information 43 around the transmitter personalized object 41 of the transmitter 10 and the transmitter personalized object 41 of the receiver 20. A display region 45 for displaying the text information 43 is provided. The transmitter personalized object 41 of the transmitter 10 and the transmitter personalized object 41 of the receiver 20 are updated and displayed according to the selected personalized object expression image 34, as shown in FIG. 4B.

After the emotional term analysis module 12 has selected one among the personalized object expression images 34, the transmitter 10 transmits the personalized object expression image 34 to the receiver 20, and the receiver 20 displays the personalized object expression image 34 and the text information 43. Alternatively, after the emotional term analysis module 12 has selected one among the personalized object expression images 34, the transmitter 10 transmits a serial number corresponding to the personalized object expression image 34 to the receiver 20, and the receiver 20 displays the personalized object expression image 34 and the text information 43.

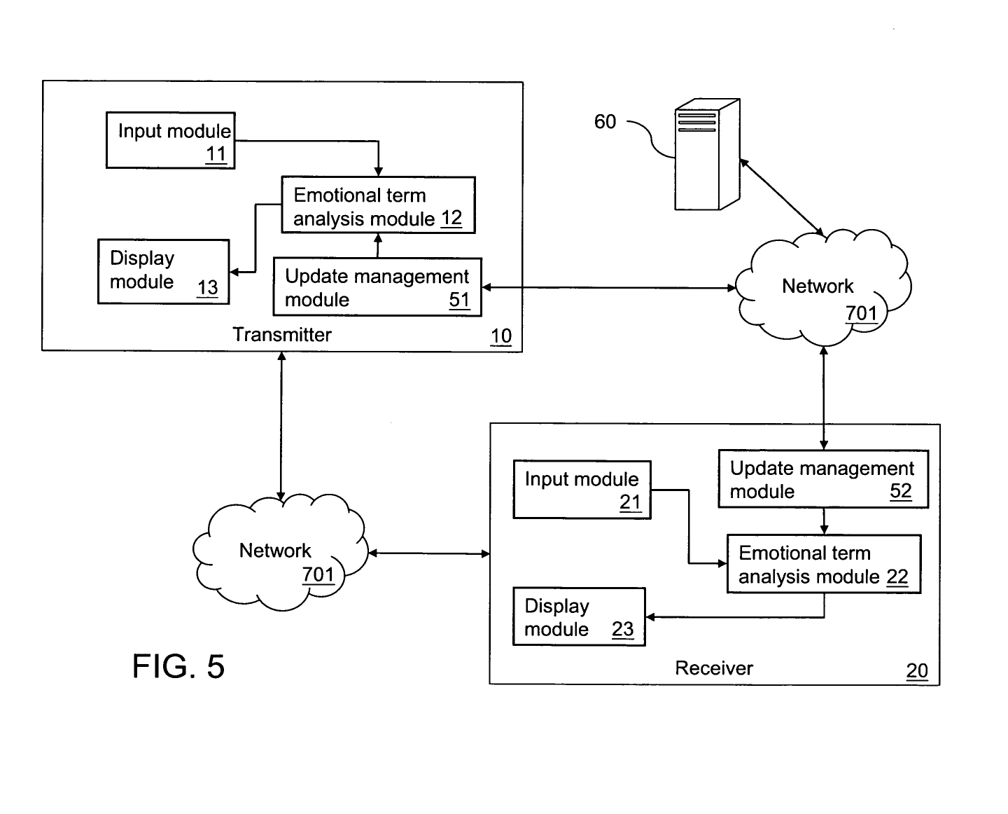

Additionally, the system further has a function of update management, and a block diagram of an update management system of the present invention is shown in FIG. 5. Compared with the block diagram of the original system, the difference lies in that the transmitter 10 and the receiver 20 additionally has an update management module 51 and an update management module 52. The update management module 51 is connected to an update management server 60 through the network 701. The update management module 51 first confirms whether the update management server 60 has an update file or not. If there is an update file, the update management module 51 will download the update file to the transmitter 10. The update management module 51 compares the emotional term classification information 31, the emotional term 32, the personalized object state 33 and the personalized object expression image 34 of the transmitter 10 with the emotional term classification information 31, the emotional term 32, the personalized object state 33, and the personalized object expression image 34 of the update file one by one, so as to make sure whether there is some difference therebetween. When there is some difference, the different database content will be written into the transmitter 10 from the update file, so as to complete the automatic update management.

The update management module 52 of the receiver 20 is connected to the update management server 60 through the network 701. The update management module 52 confirms whether the update management server 60 has an update file or not. If there is an update file, the update management module 52 will download the update file to the receiver 20. The update management module 52 compares the emotional term classification information 31, the emotional term 32, the personalized object state 33, and the personalized object expression images 34 of the receiver 20 with the emotional term classification information 31, the emotional term 32, the personalized object state 33 and the personalized object expression images 34 of the update file to make sure whether there is some difference therebetween. If there is some difference, the different database content will be written into the receiver 20 from the update file, so as to complete the automatic update management.

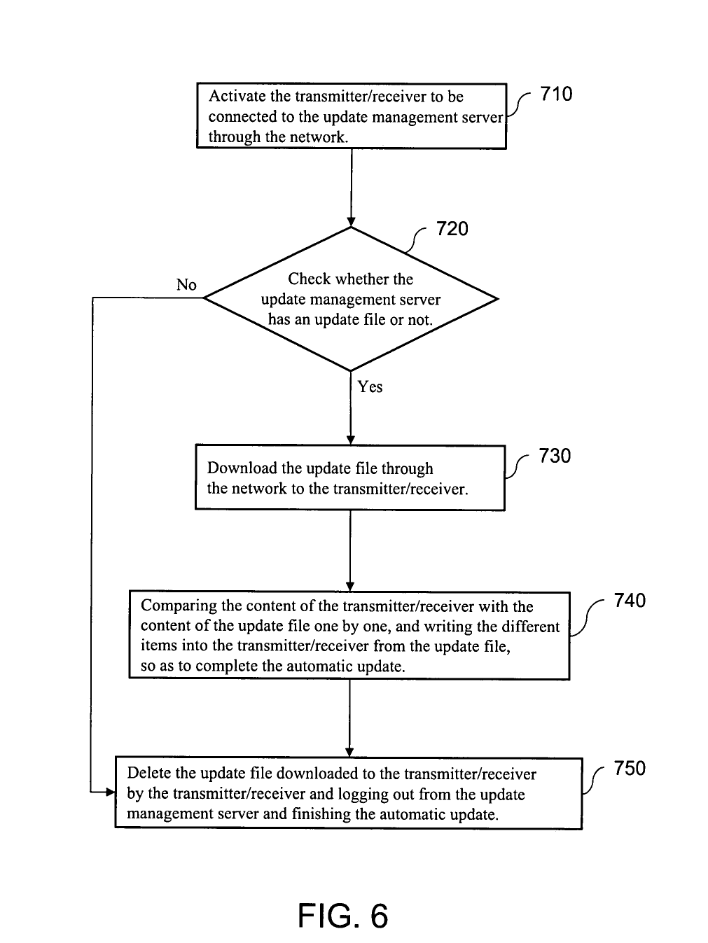

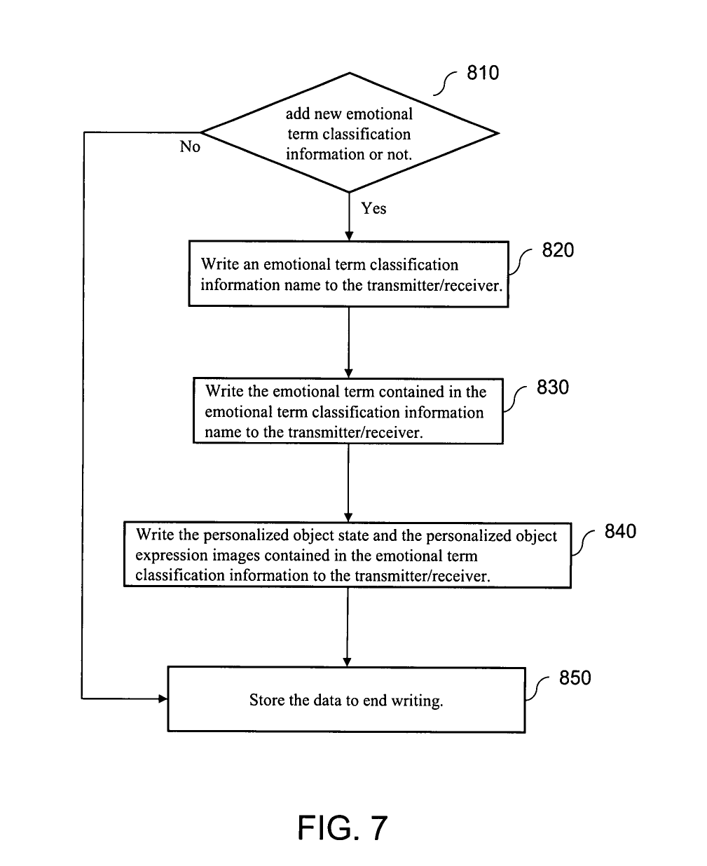

The flow chart of a corresponding method of update management functions is shown with reference to FIG. 6, which is a flow chart of update management steps of the present invention. The method of update management function includes the following steps: first, activating the transmitter 10/receiver 20 to be connected to the update management server 60 through the network (Step 710); next, checking whether the update management server 60 has an update file or not (Step 720); then, when the update management server 60 has an update file, downloading the update file through the network to the transmitter 10/receiver 20 (Step 730); thereafter, comparing the content of the transmitter 10/receiver 20 with the content of the update file one by one, and writing the different items into the transmitter 10/receiver 20 from the update file, so as to complete the automatic update (Step 740); and finally, deleting the update file downloaded to the transmitter 10/receiver 20 by the transmitter 10/receiver 20 and logging out from the update management server 60 and finishing the automatic update (Step 750). The content of the update file at least contains the emotional term classification information 31, the emotional term 32, the personalized object state 33, and the personalized object expression images 34. Referring to FIG. 7, a flow chart of steps of writing files of the present invention is shown, the step of writing into the transmitter 10/receiver 20 from update file (Step 740) includes the following steps: first, determining whether adding new emotional term classification information or not (Step 810); next, when adding new emotional term classification information, writing an emotional term classification information name to the transmitter 10/receiver 20 (Step 820); then, writing the emotional term contained in the emotional term classification information name to the transmitter 10/receiver 20 (Step 830); thereafter, writing the personalized object state and the personalized object expression images contained in the emotional term classification information to the transmitter 10/receiver 20 (Step 840); and finally, storing the data to end writing (Step 850).

According to the instant message system with personalized object and the method thereof in the present invention, by activating the function of the instant message and displaying the personalized object, the text information and the personalized object are separated, the personalized object is expressed by vivid personalized object expression images, instead of previous expression symbols, thus solving the problem that the text information is difficult to be understood when the text information contains expression symbols simultaneously. By determining whether the text information has an emotional term or not, the personalized object expression images are selected without activating the expression symbols by inputting specific key words, thus the inputting is convenient and simple, thereby achieving the efficacy of separating the text information input and personalized object expression images without influencing the understanding of the text information.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An instant message method with personalized object, applicable to instant message between a transmitter and a receiver, comprising:
receiving a text information input to the transmitter;
determining whether the text information has an emotional term or not according to emotional term classification information;
selecting a personalized object state according to the emotional term classification information when the text information has the emotional term;
selecting one among the personalized object expression images according to the personalized object state; and
displaying the text information and the personalized object expression image on the personalized objects of the transmitter and the receiver.

2. The instant message method with personalized object as claimed in claim 1, wherein the method further comprises an update management step comprising:
activating the transmitter/receiver to be connected to an update management server through network;
checking whether the update management server has an update file or not;
when the update management server has the update file, downloading the update file to the transmitter/receiver through network; and
comparing the content of the transmitter/receiver with the content of the update file one by one, and writing the different items into the transmitter/receiver from the update file, so as to complete automatic update.

3. The instant message method with personalized object as claimed in claim 2, wherein the step of writing into the transmitter/receiver from the update file further comprises:
determining whether adding new emotional term classification information or not;
when adding new emotional term classification information, writing an emotional term classification information name to the transmitter/receiver;
writing the emotional term contained in the emotional term classification information name to the transmitter/receiver; and
writing the personalized object state and the personalized object expression image contained in the emotional term classification information to the transmitter/receiver.

4. The instant message method with personalized object as claimed in claim 1, wherein the step of selecting one among the personalized object expression images further comprises a step of transmitting the personalized object expression image to the receiver by an emotional term analysis module, and displaying the personalized object expression image by the receiver.

5. The instant message method with personalized object as claimed in claim 1, wherein the step of selecting one among the personalized object expression images further comprises a step of transmitting a serial number corresponding to the personalized object expression image to the receiver by the emotional term analysis module, and displaying the personalized object expression image by the receiver.

6. An instant message system with personalized object, applicable to instant message between a transmitter and a receiver, wherein the transmitter comprises:
an input module, for receiving a text information input to the transmitter;
an emotional term analysis module, for determining whether the text information has an emotional term or not according to at least one emotional term classification information, selecting a personalized object state according to the emotional term classification information, and selecting one among personalized object expression images according to the personalized object state; and
a display module, displaying a personalized object of the transmitter and a personalized object of the receiver on the transmitter, and displaying the text information and the personalized object expression image on the personalized object of the transmitter and the receiver respectively when the text information has the emotional term.

7. The instant message system with personalized object as claimed in claim 6, wherein the transmitter further comprises an update management module, for activating the transmitter to be connected to an update management server through network, checking whether the update management server has an update file, downloading the update file to the transmitter or the receiver through network when the update management server has the update file, comparing the content of the transmitter or the receiver with the content of the update file one by one, and writing different items after comparison into the transmitter from the update file, so as to complete automatic update;
wherein, the content of the update file comprises the emotional term classification information, the emotional term, the personalized object state, and the personalized object expression image.

8. The instant message system with personalized object as claimed in claim 6, wherein the emotional term analysis module further transmits the personalized object expression image to the receiver after selecting one among the personalized object expression images.

9. The instant message system with personalized object as claimed in claim 6, wherein the emotional term analysis module further transmits a serial number corresponding to the personalized object expression image to the receiver after selecting one among the personalized object expression images.

10. The instant message system with personalized object as claimed in claim 6, wherein the input module further comprises an input region for inputting the text information; the display module further comprises a display region for displaying the text information; and the input region and the display region surrounds the personalized object in a non-overlapping manner.
